(19) United States
(12) Patent Application Publication
(10) Pub. No.: US 2022/0223126 A1
(43) Pub. Date: Jul. 14, 2022

(54) Guard for Guitar Pickup Switch

(71) Applicants: Allen Chance, Los Angeles, CA (US); William Gray, Los Angeles, CA (US)

(72) Inventors: Allen Chance, Los Angeles, CA (US); William Gray, Los Angeles, CA (US)

(21) Appl. No.: 17/570,929

(22) Filed: Jan. 7, 2022

Related U.S. Application Data
(60) Provisional application No. 63/199,569, filed on Jan. 8, 2021.

(51) Int. Cl. G10H 1/34

(52) U.S. Cl. CPC G10H 1/34; G10H 2220/265

(57) ABSTRACT

A device includes a guard structure configured to mount to a body of a guitar proximate a pickup selector lever of a pickup selector mechanism of the guitar. The guard structure includes a hood and when the guard structure is mounted to the body of the guitar over the pickup selector lever, the hood is oriented away from a pickup of the guitar. In an embodiment, when the guard structure is mounted to the body of the guitar at least a portion of the pickup selector lever is positioned within an interior volume of the hood of the guard structure.

### CROSS-REFERENCE TO RELATED APPLICATIONS

This application claims priority to and incorporates by reference U.S. Provisional Patent Application No. 63/199,569, entitled “Guard for Guitar Pickup Switch”, and filed on Jan. 8, 2021.

### TECHNICAL FIELD

This invention relates to accessories for electric instruments, particularly electric guitars, and, more particularly, to a guard for preventing a player from accidentally moving a guitar pickup selector and also to provide enhanced control over the positioning of a guitar pickup selector.

### BACKGROUND

The pickup selector is the key to the an electric guitar's time-honored tonal versatility. The selector controls which pickups or which combinations of pickups are utilized at any given time. Because the pickup selector switch protrudes from the body of the guitar, a player may occasionally bump the selector switch while playing, resulting in unwanted changes to the tone and sound of the guitar. Although a guitar's pickup selection system could be modified to include different types of switches and selectors that are not susceptible to accidental bumping, in many instances it is undesirable to change a guitar's components from those originally installed into the guitar.

Accordingly, there is a need for a non-destructive device that may easily be installed on a guitar body without modifying the body or the guitar's pickup selector system to prevent a player from accidentally striking or moving the guitar's pickup selector.

### SUMMARY

In a first aspect, the disclosure provides a device for securing a guitar selector switch in place which includes a guard, wherein the guard keeps the selector switch from being accidentally moved.

In a second aspect the disclosure provides a device for securing a guitar selector switch in place which includes a hood, which covers the selector switch above and from the front, and a handle which protrudes from under the hood. The hood keeps the selector switch from being accidentally moved. The handle enables the selector switch to be moved to discrete positions.

In some aspects, the techniques described herein relate to a device, including: a guard structure configured to mount to a body of a guitar proximate a pickup selector lever of a pickup selector mechanism of the guitar, wherein the guard structure includes a hood and when the guard structure is mounted to the body of the guitar over the pickup selector lever, the hood is oriented away from a pickup of the guitar.

In some aspects, the techniques described herein relate to a device, wherein, when the guard structure is mounted to the body of the guitar at least a portion of the pickup selector lever is positioned within an interior volume of the hood of the guard structure.

In some aspects, the techniques described herein relate to a device, wherein the guard structure includes a mounting bracket having a first hole and a second hole, and the guard structure is configured so that when the guard structure is mounted to the body of the guitar the first hole of the mounting bracket overlaps a first mounting hole of the body of the guitar and the second hole of the mounting bracket overlaps a second mounting hole of the body of the guitar.

In some aspects, the techniques described herein relate to a device, further including a switch handle configured to mount to a distal end of the pickup selector lever, wherein, when the switch handle is mounted to the pickup selector lever, the switch handle extends in a direction perpendicular to the pickup selector lever and away from the hood of the guard structure.

In some aspects, the techniques described herein relate to a device, wherein an interior surface of the hood of the guard structure includes a detent.

In some aspects, the techniques described herein relate to a device, wherein the pickup selector mechanism is configured to define a first pickup position of the pickup selector lever and a second pickup position of the pickup selector lever and the detent is configured to engage with the pickup selector lever to retain the pickup selector lever in a third pickup position that is between the first pickup position and the second pickup position.

In some aspects, the techniques described herein relate to a device, including: a hood configured to mount to a body of a guitar proximate a pickup selector lever of the guitar, wherein when the hood is mounted to the body of the guitar, at least at least a portion of the pickup selector lever is positioned within an interior volume of the hood.

In some aspects, the techniques described herein relate to a device, wherein the hood includes a mounting bracket having a first hole and a second hole, and the hood is configured so that when the hood is mounted to the body of the guitar the first hole of the mounting bracket overlaps a first mounting hole of the body of the guitar and the second hole of the mounting bracket overlaps a second mounting hole of the body of the guitar.

In some aspects, the techniques described herein relate to a device, further including a switch handle configured to mount to a distal end of the pickup selector lever, wherein, when the switch handle is mounted to the pickup selector lever, the switch handle extends in a direction perpendicular to the pickup selector lever and away from the hood.

In some aspects, the techniques described herein relate to a device, wherein an interior surface of the hood includes a detent.

In some aspects, the techniques described herein relate to a method, including: providing a guard structure configured to mount to a body of a guitar proximate a pickup selector lever of a pickup selector mechanism of the guitar, wherein the guard structure includes a hood; and mounting the guard structure to the body of the guitar over the pickup selector lever so that the hood is oriented away from a pickup of the guitar.

In some aspects, the techniques described herein relate to a method, wherein, when the guard structure is mounted to the body of the guitar, at least a portion of the pickup selector lever is positioned within an interior volume of the hood of the guard structure.

In some aspects, the techniques described herein relate to a method, wherein the guard structure includes a mounting bracket having a first hole and a second hole, and mounting the guard structure further including positioning the guard structure so that the first hole of the mounting bracket overlaps a first mounting hole of the body of the guitar and the second hole of the mounting bracket overlaps a second mounting hole of the body of the guitar.

In some aspects, the techniques described herein relate to a method, further including mounting a switch handle to a distal end of the pickup selector lever so that the switch handle extends in a direction perpendicular to the pickup selector lever.

In some aspects, the techniques described herein relate to a method, wherein an interior surface of the hood of the guard structure includes a detent.

In some aspects, the techniques described herein relate to a method, wherein the pickup selector mechanism is configured to define a first pickup position of the pickup selector lever and a second pickup position of the pickup selector lever and the detent is configured to engage with the pickup selector lever to retain the pickup selector lever in a third pickup position that is between the first pickup position and the second pickup position.

Further aspects and embodiments are provided in the foregoing drawings, detailed description, and claims.

### BRIEF DESCRIPTION OF THE DRAWINGS

The drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1A depicts a body of a guitar and illustrates the locations of control elements and pickups that are mounted to the body of the guitar.

FIG. 1B is a table depicting pickup selection options for a guitar including a five-position pickup selector switch.

FIG. 2 depicts an embodiment of a guard for a pickup selector switch.

FIG. 3 is a perspective view of a pickup switch handle.

FIG. 4 is a perspective view of a hood for a switch selector.

FIG. 5 is a view of a switch selector hood and handle installed on a guitar.

FIG. 6 is a view of one step of the installation of a switch selector hood and handle.

### DETAILED DESCRIPTION

The following description recites various aspects and embodiments of the invention disclosed herein. No particular invention or description of any embodiment or any invention is intended to define the scope of the invention. Rather, the embodiments described herein provide non-limiting examples of various devices, systems, compositions, and methods that are included within the scope of the claimed invention. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly indicates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only to aid in understanding embodiments illustrated in the present disclosure and are not meant to be limiting in any fashion. Nor do these phrases indicate any kind of preference for the disclosed embodiment.

As used herein “pickup” is meant to refer to a device on a guitar that converts the vibrations of the strings into electrical signals.

The pickup selector is the key to electric guitar time-honored tonal versatility, because it controls which pickups or which combinations of pickups are on at any given time.

In some guitar designs, a five-position blade-type switch is mounted diagonally on the lower half of the guitar pickguard on the treble-strings side, just forward of the guitar's control knobs. Such placement of the pickup selector is entirely deliberate—close enough to the strumming/picking hand to be within easy reach while playing, but far enough out of the way that it's unlikely to be accidentally knocked out of position.

Some three-pickup guitars were initially manufactured with three-position pickup selector switches meaning that a player was only anticipated to activate a single pickup at a time. Guitarists have discovered, however, that by somewhat precariously lodging the pickup selector switch in one of the two “in-between” spots—between the bridge and middle pickup positions (e.g., between the first and second pickup selector switch position) or between the middle and neck pickup positions (e.g., between the second and third pickup selector switch position)—they could get two different dual-pickup combinations. They have learned that turning on the bridge and middle pickups together produced a rich and distinctive sound of its own; same with turning on the middle and neck pickups together.

These in-between positions sound different because it causes two adjacent guitar pickups to be energized at the same time, so that pickups in different positions respond differently to string vibrations, cancelling out certain frequencies when operating simultaneously.

When positioning a three-position pickup selector switch in the “in-between” positions, the pickup selector switch is precariously balanced between two of its stable positions. As such, any small disturbance to the switch (e.g., via a player's hand or simply movement or agitation of the guitar) can cause the selector switch to fall into one of its three stable positions, causing the desired in-between sound to be lost.

To provide more stability, the hardware and electronics of a guitar with three pickups and a three-position pickup selector switch could be modified to incorporate a five-position selector switch to allow the player to enjoy the “in-between” sounds in stable positions 2 and 4 of the five-position selector switch. However, in nearly all cases, it is undesirable to modify a guitar's original electronic components as such modifications can reduce the value of vintage guitars originally manufactured with three-position selector switches.

To remedy these deficiencies, the present disclosure provides a novel device configured to be installed over and around a three-position pickup selector switch to provide the selector switch with 5 distinct stable resting locations enabling confident use of the in-between sounds. The device includes several parts. First, there is a handle that fits on the selector switch itself. The handle protrudes at an about 45-degree angle. Second, the device includes a guard or shield fits over the switch.

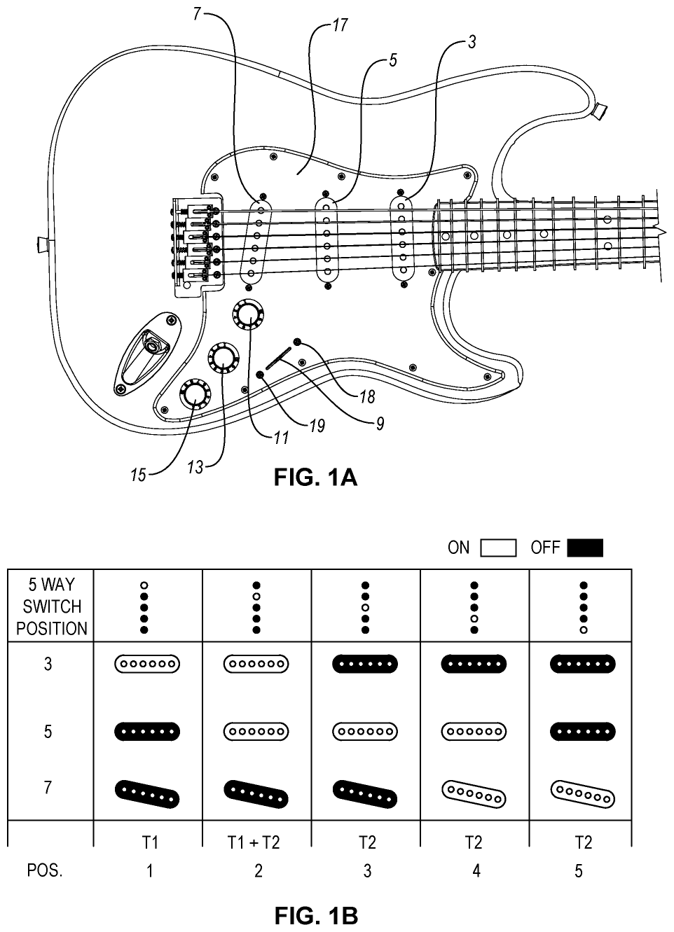

Now referring to FIG. 1A which depicts a body of an electric guitar. The electric guitar has three pickups, a neck pickup 3, a middle pickup 5, and a bridge pickup 7. The guitarist can choose using the selector switch 9 which of the three pickups transmits the vibrations of the strings. Selector switch 9 has a number of stable positions and the guitarist selects a particular pick by moving the selector switch 9 into one of those stable positions.

If the selector switch 9 is a three-position selector switch, the guitarist can choose to select the neck pickup 3 by positioning the selector switch 9 into its first stable position, which will register the vibrations of the strings near the neck of the guitar. Or the guitarist can select the middle pickup 5 by positioning the selector switch 9 in its second stable position. Similarly, the guitarist can select the bridge pickup 7 by positioning the selector switch 9 in its third stable position.

The guitarist controls the volume with knob 11, and the tone with knobs 13 and 15.

In other types of electric guitars, the selector switch 9 may be a five-position selector switch. To illustrate, FIG. 1B is a table depicting pickup selection options for a guitar including a five-position pickup selector switch. In that case, the additional two stable positions for the five-position selector switch may be used to generate sounds that incorporate the vibrations from two pickups simultaneously, giving greater options to the possibilities for sound mixing and sound creation. For example, in the pickup selector's first position, only the neck pickup 3 is activated. In the pickup selector's second position, both the neck pickup 3 and the middle pickup 5 are activated, thereby achieving a first in-between sound. In the pickup selector's third position, only the middle pickup 5 is activated. In the pickup selector's fourth position, both the middle pickup 5 and the bridge pickup 7 are activated simultaneously, thereby achieve a second in-between sound. In the pickup selector's fifth position, only the bridge pickup 7 is activated.

During playing, the guitarist may accidentally knock the pickup selector switch 9 and change the pickup switch 9 configuration without meaning to.

The guitar depicted in FIG. 1A includes a pickguard 17 mounted to the body of the guitar via a number of fasteners. Proximate to pickup selector switch 9, fastener 18 and fastener 19 are configured to assist in securing pickguard 17 to the body of the guitar and are also configured to engage with and secure portions of pickup selector switch 9. In embodiments, fastener 18 and fastener 19 are screw-type fasteners.

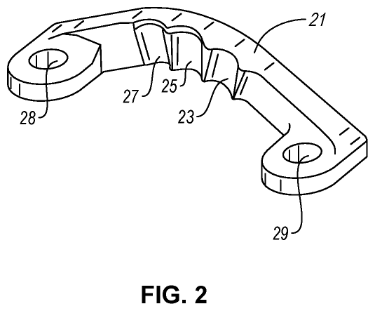

FIG. 2 depicts a guard structure or hood 21 that may be attached to a body of a guitar (e.g., the guitar of FIG. 1A) via suitable fasteners (e.g., fastener 18 and fastener 19, FIG. 1A). Referring to FIG. 2, in one embodiment, a bar or guard 21 attaches to the guitar. The guard 21 includes a number of detents (also referred to herein as notches or indentations) that are configured to define positive stop locations of the guitar's pickup selector switch and to provide resistance to the pickup selector switch moving from one position to another. The pickup selector switch is configured as a pickup selector lever that is incorporated into a pickup selector mechanism mounted into the guitar. In the depicted embodiment, the guard 21 has indentations or notches 23, 25, and 27 formed along a first side surface of guard 21. The notches 23, 25, 27 correspond to pickup selector locations. When mounted to the guitar, the first side surface of guard 21 is positioned so that the tall regions of guard 21 between notches 23, 25, 27 contact the pickup selector switch as it moves from one pickup selector location to another. This configuration ensures that the notches 23, 25, 27 positively locate the selector for the desired pickup configuration, and, to some degree, the tall regions of guard 21 between notches 23, 25, 27 provides some resistance to the pickup selector switch changing position because a user must push the selector switch past the tall regions of guard 21 between notches 23, 25, 27 in order to change the pickup selector switch positioned.

In the configuration depicted in FIG. 2, notch 23 corresponds to a neck pickup selector switch position. Indentation 25 corresponds to a middle pickup selector switch position. Indentation 27 corresponds to a bridge pickup selector switch position.

Guard 21 is configured to protect the switch by positioning itself between the switch and the strings where the guitarist is strumming. Additionally, notches 23, 25, 27 hold or retain the pickup selector switch in place reducing the likelihood of inadvertent movement of the selector switch. The ability of the guard to inhibit movement of the selector switch out of one its pickup selection locations is determined by the pressure of the guard 21 against the pickup selector switch.

The amount of pressure that the guard 21 applies to the pickup selector switch to inhibit movement of the switch can be adjusted because the mechanism (e.g., screw holes) by which guard 21 is mounted to the body of the guitar allows the position of the guard 21 with respect to the guitar's pickup selector switch to be adjusted. In the embodiment depicted in FIG. 2, mounting hole 28 and mounting hole 29 are elongated, which, when mounted to the guitar body (e.g., via fastener 18 and fastener 19), allows the guard 21 to be positioned closer to or further from the pickup selector switch. This ensures that the pickup that the guitarist chooses remains the pickup that transmits the sounds and the pickup selector switch is not accidentally dislodged.

One advantage of this embodiment is that it does not require any changes to the pickup selector switch of the guitar itself. The only change to the guitar is the addition of the switch guard using pre-existing fasteners and fastening locations. As such, the guard 21 does not require any of the existing components of the guitar to be modified.

In this depicted configuration, the guard 21 includes three notches that correspond to the three pickup positions, in alternative embodiments the guard 21 may include more or fewer notches or indentations, such as five notches. The embodiments that include five notches may be used with guitars that include five-position pickup selector switches. Additionally, embodiments in which the guard 21 includes five notches can be used with guitars manufactured with three-position pickup selector switches to effectively render the three-position pickup selectors them into five-position pickup selectors. In an embodiment, the guard is made of plastic. The plastic may be molded or printed into shape. In alternative embodiments, the switch guard 21 is made of metal such as aluminum, titanium, or steel. The metal may be cast, machined, or printed into shape. In yet other embodiments, the guard is made of wood.

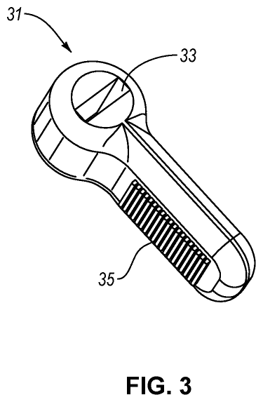

In some embodiments, the present device includes an auxiliary switch handle that may be mounted to the pickup selector lever of a pickup selector switch to facilitate operation of the pickup selector switch lever. To illustrate, FIG. 3 depicts a switch handle 31 that may be mounted to a pickup selector switch lever in accordance with the present disclosure. The switch handle 31 includes an aperture 33 into which a distal end of the pickup selector switch fits. The original switch head is removed and the switch handle 31 is placed on the switch. The switch handle 31 extends ninety degrees from the plane of the switch. The switch handle 31 includes grips 35 on each side of the handle. In the preferred embodiment, the handle is made from plastic. The plastic may be molded or printed into shape. In alternative embodiments, the switch guard is made of metal such as aluminum, titanium, or steel. The metal may be cast, machined, or printed into shape. In yet other embodiments, the guard is made of wood.

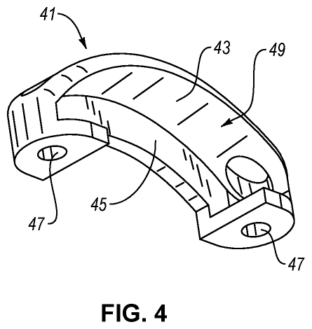

In some embodiments, the switch guard may be configured as a hood to provide a protective structure disposed between the strumming portion of the strings of a guitar and the guitar's pickup selector switch or lever to prevent accidental contact with the pickup selector switch. Such an embodiment is depicted in FIG. 4 in which guard structure or hood 41 is configured to be mounted to a guitar and to sit over or otherwise partially enclose a portion of the guitar's pickup selector switch lever. Hood 41 may be mounted to a guitar via fasteners (e.g., fastener 18 and fastener 19, FIG. 1A) being inserted through mount holes 47 formed in a mounting bracket of hood 41. Specifically, hood 41 includes a mounting bracket having first and second mount holes 47, and the hood and mounting bracket is configured so that when the hood is mounted to the body of the guitar the first hole 47 of the mounting bracket overlaps a first mounting hole of the body of the guitar (e.g., the hole to which fastener 18, FIG. 1A attaches) and the second hole 47 of the mounting bracket overlaps a second mounting hole (e.g., the hole to which fastener 19, FIG. 1A attaches) of the body of the guitar.

In the embodiment depicted in FIG. 4, the hood 41 includes top portion 43, and side portion 45. The side portion 45 and top portion 43 form a hood that covers the switch handle. When mounted to a guitar, the hood formed by side portion 45 and top portion 43 forms an opening 49 that is oriented away from the strumming area of the guitar's strings. Consequently, the side portion 45 and top portion 43 are a solid structure that sits between the guitar's pickup selector lever and the strumming area of the guitar's strings thereby prevent unintentional contact between the guitar player's strumming hand and the guitar's pickup selector switch.

In this configuration, although the pickup selector lever is disposed within an interior volume of the hood 41, the handle (e.g., handle 31) that is mounted to the pickup selector lever extends in a direction perpendicular to the pickup selector lever and out from under the hood 41. This enables the player to modify a position of the guitar's pickup selector lever by reaching over the hood 41 and applying force to the handle 31 to move the pickup selector lever.

As such, the hood and handle form a switch guard that enables the guitarist to play without concern for accidentally striking the guitar's pickup selector lever and thereby changing the pickup used and thus the tone and sound the guitarist desires to produce. In an embodiment, the underneath side of the hood is smooth (e.g., as depicted in FIG. 4). In an alternative embodiment, the underneath side (i.e., the interior surface of either the side portion 45 and/or the top portion 43 of hood 41 includes detents, indentations, or notches (e.g., the notches of FIG. 2) that hold the pickup selector lever in positions to determine which pickup is used. In the embodiments with notches some embodiments include three notches while other embodiments include five notches. The embodiments that include five notches may be used with guitars made with five pickup positions. Additionally, the embodiments with five notches can be used with guitars manufactured with three pickup positions, to turn them into five pickup position guitars. In the preferred embodiment, the hood is made of plastic. The plastic may be molded or printed into shape. In alternative embodiments, the switch guard is made of metal such as aluminum, titanium, or steel. The metal may be cast, machined, or printed into shape. In yet other embodiments, the guard is made of wood.

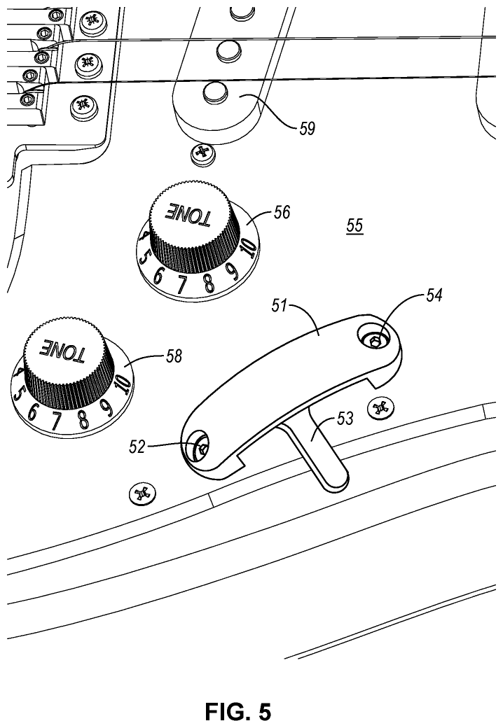

FIG. 5 shows a switch guard hood 51 (e.g., hood 41, FIG. 4) and switch guard handle 53 (e.g., handle 31, FIG. 3) installed on a guitar. The guitar includes a guitar body 55 include various control interfaces including volume knob 56 and tone knob 58. The view depicted in FIG. 5 also shows pickup 59. As depicted in FIG. 5, the switch guard hood 51 is mounted to body 55 by fastener 52 and 54 (e.g., fastener 18 and fastener 19) fits over the guitar pickup selector lever (not visible in FIG. 5). Handle 53 is mounted to the guitar's pickup selector lever and at least partially protrudes from underneath hood 51, as is illustrated in FIG. 5. Furthermore, as depicted in FIG. 5, hood 51 is mounted to the guitar body 55 so that the hood (and, specifically, the hood opening) is oriented away from the strumming area of the strings which would be towards the top of FIG. 5. The switch guard handle 53 protrudes out from under the switch guard hood 51. With the handle 53 so protruding, the guitarist can move the selector switch to a position, and keep the selector switch in the chosen location with reduced risk of accidentally striking the guitar pickup selector lever while playing the guitar.

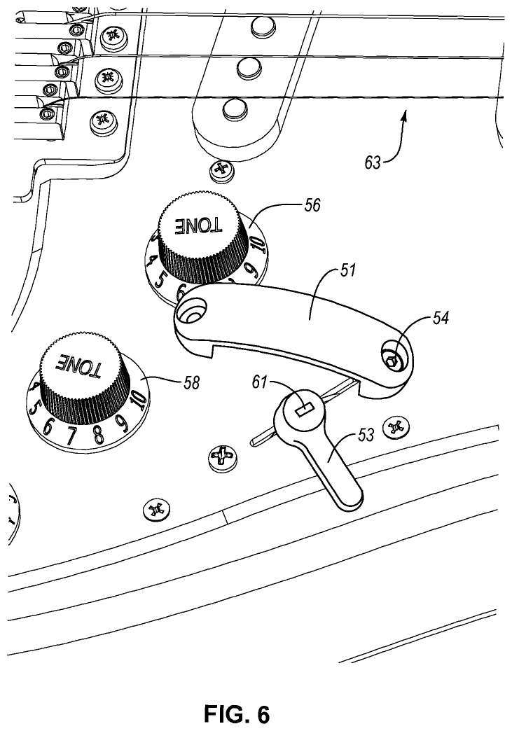

FIG. 6 depicts the guitar body of FIG. 5 in which the guard hood 51 has been partially removed so as to illustrate the installation of both the switch guard handle 53 on the guitar's pickup selector lever and the guard hood 51. During an installation process, the switch guard handle 53 is first secured to an end of the pickup selector switch lever 61. In embodiments, the handle 53 may be secured via a friction-fit coupling to the end of the lever 61. In other embodiments, other types of fasteners including threaded portions, bolts, clamps, glues, and the like may be used to secure handle 53 to lever 61. Handle 53 is secured to lever 61 in a manner so that handle 53 generally extends away from the strumming region 63 of the guitar's strings.

With handle 53 secured to the pickup selector lever 61, the hood 51 is attached to the guitar body using the same screw holes that secure the original switch selector to the guitar (e.g., the screw holes to which fasteners 18, 19 are attached in FIG. 1A). The original screws are removed and screws of the same thread height, and thread depth with increased thread length are used to install the hood. The screws need a longer length to accommodate the addition of the hood material. In the preferred embodiment, to install the device, one of the switch screws is removed, and replaced with a 6-32 low profile, Allen head machine screw. This enables the screws and guard to avoid interference with the selector. Hood 51 can be molded, machined, cast or 3-D printed in plastics or metals. In the preferred embodiment there is a shield covering and partially enclosing the right-angle selector knob, and switch mechanism from accidental contact.

All patents and published patent applications referred to herein are incorporated herein by reference. However, any reference to prior publication is not, and should not be taken as an acknowledgement, admission, or suggestion that the prior publication, or any information derived from it is part of the general common knowledge in the field of endeavor to which this specification relates. The invention has been described with reference to various specific and preferred embodiments and techniques. Nevertheless, it is understood that many variations and modifications may be made while remaining within the spirit and scope of the invention.

What is claimed is:

1. A device, comprising:
a guard structure configured to mount to a body of a guitar proximate a pickup selector lever of a pickup selector mechanism of the guitar, wherein the guard structure includes a hood and when the guard structure is mounted to the body of the guitar over the pickup selector lever, the hood is oriented away from a pickup of the guitar.

2. The device of claim 1, wherein, when the guard structure is mounted to the body of the guitar at least a portion of the pickup selector lever is positioned within an interior volume of the hood of the guard structure.

3. The device of claim 1, wherein the guard structure includes a mounting bracket having a first hole and a second hole, and the guard structure is configured so that when the guard structure is mounted to the body of the guitar the first hole of the mounting bracket overlaps a first mounting hole of the body of the guitar and the second hole of the mounting bracket overlaps a second mounting hole of the body of the guitar.

4. The device of claim 1, further comprising a switch handle configured to mount to a distal end of the pickup selector lever, wherein, when the switch handle is mounted to the pickup selector lever, the switch handle extends in a direction perpendicular to the pickup selector lever and away from the hood of the guard structure.

5. The device of claim 1, wherein an interior surface of the hood of the guard structure includes a detent.

6. The device of claim 5, wherein the pickup selector mechanism is configured to define a first pickup position of the pickup selector lever and a second pickup position of the pickup selector lever and the detent is configured to engage with the pickup selector lever to retain the pickup selector lever in a third pickup position that is between the first pickup position and the second pickup position.

7. A device, comprising:
a hood configured to mount to a body of a guitar proximate a pickup selector lever of the guitar, wherein when the hood is mounted to the body of the guitar, at least at least a portion of the pickup selector lever is positioned within an interior volume of the hood.

8. The device of claim 7, wherein the hood includes a mounting bracket having a first hole and a second hole, and the hood is configured so that when the hood is mounted to the body of the guitar the first hole of the mounting bracket overlaps a first mounting hole of the body of the guitar and the second hole of the mounting bracket overlaps a second mounting hole of the body of the guitar.

9. The device of claim 7, further comprising a switch handle configured to mount to a distal end of the pickup selector lever, wherein, when the switch handle is mounted to the pickup selector lever, the switch handle extends in a direction perpendicular to the pickup selector lever and away from the hood.

10. The device of claim 9, wherein an interior surface of the hood includes a detent.

11. A method, comprising:
providing a guard structure configured to mount to a body of a guitar proximate a pickup selector lever of a pickup selector mechanism of the guitar, wherein the guard structure includes a hood; and
mounting the guard structure to the body of the guitar over the pickup selector lever so that the hood is oriented away from a pickup of the guitar.

12. The method of claim 11, wherein, when the guard structure is mounted to the body of the guitar, at least a portion of the pickup selector lever is positioned within an interior volume of the hood of the guard structure.

13. The method of claim 11, wherein the guard structure includes a mounting bracket having a first hole and a second hole, and mounting the guard structure further comprising positioning the guard structure so that the first hole of the mounting bracket overlaps a first mounting hole of the body of the guitar and the second hole of the mounting bracket overlaps a second mounting hole of the body of the guitar.

14. The method of claim 11, further comprising mounting a switch handle to a distal end of the pickup selector lever so that the switch handle extends in a direction perpendicular to the pickup selector lever.

15. The method of claim 11, wherein an interior surface of the hood of the guard structure includes a detent.

16. The method of claim 15, wherein the pickup selector mechanism is configured to define a first pickup position of the pickup selector lever and a second pickup position of the pickup selector lever and the detent is configured to engage with the pickup selector lever to retain the pickup selector lever in a third pickup position that is between the first pickup position and the second pickup position.
